(19) United States
(12) Patent Application Publication
(10) Pub. No.: US 2024/0054450 A1
(43) Pub. Date: Feb. 15, 2024

(54) ARTICLE SUPPLY DEVICE MANAGING METHOD, USER INTERFACE, ARTICLE SUPPLY DEVICE MANAGING APPARATUS AND PROGRAM THEREFOR

(71) Applicant: BANDAI CO., LTD., Tokyo (JP)

(72) Inventors: Hajime KONDO, Tokyo (JP); Hiroki KOBAYASHI, Tokyo (JP)

(21) Appl. No.: 18/260,471

(22) PCT Filed: Dec. 27, 2021
(86) PCT No.: PCT/JP2021/048679

§ 371 Date: Jul. 5, 2023

(30) Foreign Application Priority Data
Jan. 6, 2021 (JP) 2021-000912

(51) Int. Cl. G06Q 10/087; G06Q 30/0601

(52) U.S. Cl. CPC G06Q 10/087; G06Q 30/0639; G06Q 30/0643

(57) ABSTRACT

In an article supply device managing method, arrangement information in a sales area and article information of each article supply device in the sales area is acquired from an article supply device database, which stores the arrangement information relating to a layout of the respective article supply devices arranged in the sales area and the article information relating to an article which can be supplied from each article supply device arranged in the sales area, and a layout image where an object image of each article supply device corresponding to the arrangement of the article supply devices in the predetermined sales area is arranged is displayed on a terminal a user operates, by using the article information and the arrangement information of each article supply devices in the predetermined sales area. The object image includes article information of the article supply device corresponding to the object image.

### TECHNICAL FIELD

The present invention relates to an article supply device managing method, a user interface, an article supply device managing apparatus and a program therefor, and specifically relates to an article supply device managing method relating to management of an article supply device, a user interface, an article supply device managing apparatus and a program therefor.

### BACKGROUND

Disclosed below is a technology relating to a real time store management system capable of getting machine sales in a store, gift cost, expenses, final profit in real time, including cost calculation (Patent Document 1).

### PRIOR ART

### Patent Documents

[Patent Document 1] Japanese Patent Application Publication No. 2003-331085

### SUMMARY

### Technical Problem

However, in the above-disclosed invention, a situation of the layout of devices in a store, which supplies a gift(s), is not taken into consideration.

In view of the above problem, the present invention is made and it is an object of the present invention to provide an article supply device managing method relating to management of article supply devices, a user interface, an article supply device managing apparatus and a program therefor, in which each article supply device is managed on a management screen of the article supply device, taking a layout of each article supply device installed in a sales area, into consideration.

### Solution to Problem

One of the aspects of the present invention is an article supply device managing method, in which arrangement information in a predetermined sales area and article information of each of article supply devices in the predetermined sales area is acquired from an article supply device database, which stores the arrangement information and the article information. The arrangement information relates to a layout of the respective article supply devices installed in the sales area and the article information relates to an article(s) which can be supplied from each of the article supply devices arranged in the sales area. And in the article supply device managing method, a layout image where an object image of each of the article supply devices is arranged corresponding to the layout of the article supply devices in the predetermined sales area is displayed on a terminal a user operates, by using the article information and the arrangement information of the respective article supply devices in the predetermined sales area, and the object image includes the article information of article supply device corresponding to the object image.

Another aspect of the present invention is a user interface. In the user interface, a layout image in which an object image of each of article supply devices is arranged is displayed, corresponding to a layout of the respective article supply device in a predetermined sales area. The object image includes article information relating to an article(s) which can be supplied from the article supply device corresponding to the object image. A selection of an article supply device for which article information is to be changed or a selection of an article supply device for which the arrangement thereof is to be changed, can be made by selecting the object image.

Still another aspect of the present invention is an article supply device managing apparatus. The article supply device managing apparatus comprises an acquiring unit which acquires arrangement information of each of article supply devices in a predetermined sales area and article information of each article supply device in the predetermined sales area from an article supply device database, which stores the arrangement information and the article information; and a display control unit which displays a layout image where an object image of each of the article supply devices is arranged corresponding to the layout of the article supply devices in the predetermined sales area, on a terminal a user operates, by using the article information and the arrangement information of the respective article supply devices in the predetermined sales area. The arrangement information relates to a layout of the respective article supply devices arranged in the sales area and the article information relates to an article(s) which can be supplied from each of the article supply devices arranged in the sales area. The object image includes the article information of the article supply device corresponding to the object image.

Still another aspect of the present invention relates to a program. The program causes a computer to function as an acquisition unit which acquires layout information including arrangement information relating to a layout of the respective article supply devices installed in the sales area and article information relating to an article(s) which can be supplied from each of the article supply devices, and a display control unit which displays a layout image where an object image of each of the article supply devices corresponding to the layout of the article supply devices in the predetermined sales area is arranged by using the layout information, wherein the object image includes the article information of the article supply device corresponding to the object image.

### Advantageous Effect of Invention

According to the present invention, it is possible to manage each article supply device from an article supply device management screen thereof for which a layout of the respective article supply devices arranged in a sales area is taken into consideration.

### BRIEF DESCRIPTION OF DRAWINGS

FIG. 1 is a schematic diagram of a management system according to an embodiment;

FIG. 2 illustrates a configuration example of a tablet type computer which is an example of a terminal 2;

FIG. 3 shows an example of article supply device information and article information recorded in an article supply device database 4 (article supply device DB 4);

FIG. 4 is a block diagram showing an example of a functional configuration of the terminal 2;

FIG. 5 is a block diagram showing a functional configuration of a management server 3;

FIG. 6 shows an example of a basic layout map;

FIG. 7 is a diagram showing an example of layout information;

FIG. 8 is a diagram showing an example of an object image;

FIG. 9 is a diagram showing an example of an object image;

FIG. 10 is a diagram showing an example of a layout image;

FIG. 11 is a sequence diagram of the entire management system;

FIG. 12 is a diagram showing an example of an initial screen of the terminal 2;

FIG. 13 is a flowchart of layout image generation processing;

FIG. 14 is a diagram showing an example of the layout image displayed on the terminal 2;

FIG. 15 is a flowchart of replenishment, replacement, installation; and removal processing (Step 7);

FIG. 16 is a flowchart of the replenishment, replacement, installation, or removal and update processing in the management server 3;

FIG. 17 is a diagram showing an example of an operation of the terminal 2 in case of replenishment of articles;

FIG. 18 is a diagram showing an example of an input screen for “the replenishment”;

FIG. 19 is a diagram showing an example of a layout image after a stock quantity of a selected article supply device is updated;

FIG. 20 is a diagram showing an example of an operation of the terminal 2 in case of replenishment of articles;

FIG. 21 is a diagram showing an example of an input screen for “replacement of articles”;

FIG. 22 is a diagram showing an example a layout image after articles ID supplied by a selected article supply device 1 and stock quantity thereof are updated;

FIG. 23 is a diagram showing an example of an operation of the terminal 2 in case of installation of a new article supply device;

FIG. 24 is a diagram of an example of an input screen for “installation”;

FIG. 25 is a diagram showing an example of a layout image after the newly installed article supply device is updated;

FIG. 26 is a diagram showing an example of an operation of the terminal 2 in case of removal of an article supply device 1;

FIG. 27 is a diagram showing an example of an input screen of the “removal”; and

FIG. 28 is a diagram showing an example of an updated layout image after the removed article supply device is removed.

### DETAILED DESCRIPTION

### Embodiment of the Present Invention

Embodiments of the present invention will be described below.

### [Overall Configuration]

Described below is an article supply system according to the present embodiment.

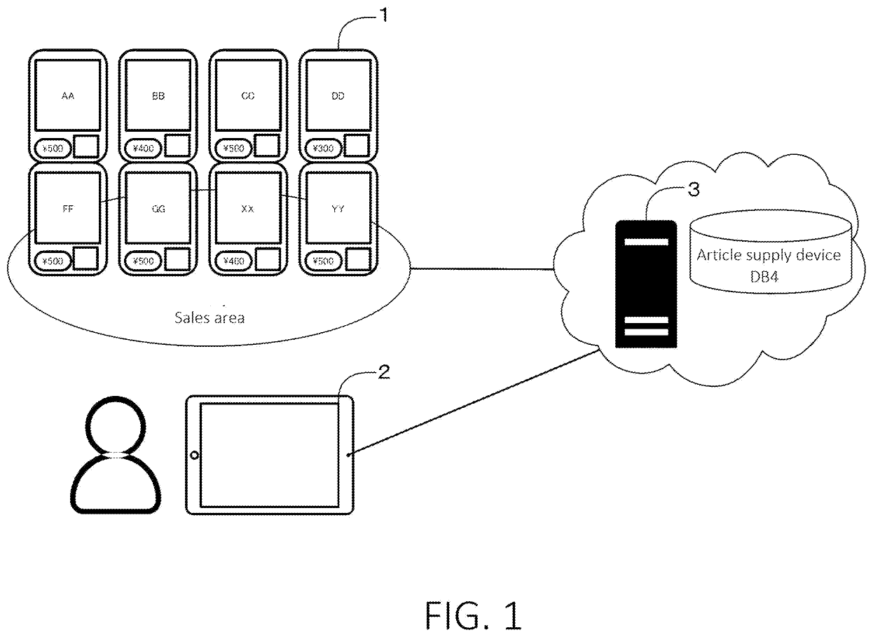

FIG. 1 is a schematic diagram of a management system according to the present embodiment. In FIG. 1, article supply devices installed in a sales area, a user terminal, a management server, and an article supply device database are respectively denoted by 1, 2, 3 and 4.

The article supply device 1, the user terminal 2 and the management server 3 can be connected to a communication line and can communicate with one another. The communication line means a communication channel capable of data transmission. That is, the communication line includes a communication network, such as a telephone communication network, a cable network, the internet, etc., in addition to a LAN established by a dedicated line (dedicated cable) for direct connection or an Ethernet (registered trademark) and the like. A communication can be performed by any method, and may be either wired or wireless.

The article supply devices 1 are installed in one or more sales areas. Each article supply device 1 is a device which supplies (provides) an article(s). Each article supply device 1 has an article storage unit in which articles are stored. As such an article, a toy etc. may be enclosed in each of capsules which is dividable and has a spherical shape, or a toy and a capsule may be formed in an integrated fashion. Such an article is not limited to one kind but two or more kinds articles may be stored therein. In such case, the two or more kinds of articles, are mixed and stored, as articles which belong to a certain series (category), in the article storage unit of each article supply device 1.

A handle, which functions as an operation unit, and a take-out port to which an article(s) is supplied, are provided on the front face of each article supply device 1. A rotary table having a hole is provided in a lower part of the article storage unit. The hole has such a size that an article can pass therethrough. When the handle is rotated by a certain angle, the rotary table is rotated in association therewith, and when the hole of the rotary table and a drop opening formed in the bottom of the article storage unit face each other one of the articles passes through a path connected to the take-out port, and is supplied to the take-out port.

In addition, each of the article supply devices 1 has such a function that every time one of the articles is discharged by rotating the handle, the article supply device 1 detects it, and the article supply device 1 informs the management server 3 of the information (discharge information) which indicates one of the articles is discharged. However, it is not limited thereto. That is the management server 3 may be informed of it through a management device installed in the sales area. In addition, the discharge information is not necessarily transmitted every time an articles is discharged. The number of times an article is discharged may be collectively reported thereto every predetermined time.

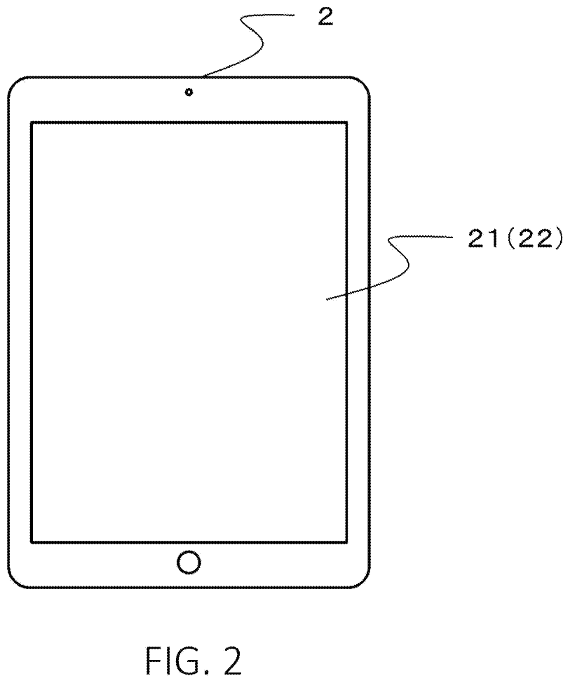

The terminal 2 is, for example, a personal computer, a tablet type computer, a smart phone, a cell phone or the like. FIG. 2 is a diagram showing an example of the device configuration of the tablet type computer as an example of the terminal 2. As shown in FIG. 2, the terminal 2 comprises a display 21, a touch operation panel 22 integrally formed with the display 21. In addition, although not illustrated, a control board, a built-in battery, s power button, a sound volume adjusting button and the like are provided in the terminal 2.

On the control board, various microprocessor(s) such as a CPU, a GPU, a DSP, etc., various IC memories such as an ASIC, a VRAM, a RAM, a ROM etc., a wireless communication module for wirelessly communicating with a base station and the like are mounted. Further, on the control board, a so-called I/F circuit (interface circuit) such as a driver circuit for the touch operation panel 22, etc., is mounted. These elements mounted on the control board are electrically connected with one another via a bus circuit etc., and are connected so as to be able to read and write data, and to transmit and receive a signal(s).

The management server 3 is a server system which includes one or more server apparatuses and memory devices etc. in the configuration thereof. In the article supply device database 4, article supply device information relating to the article supply devices 1, and article information relating to articles which are supplied from the article supply devices 1, is recorded. In addition, the management server 3 and the article supply device database 4 may be provided on a cloud.

The article supply device information includes article supply device identification information (article supply device ID) which is identification information uniquely assigned to each article supply device 1; information of a sales area (shop) where the article supply devices 1 are installed; article identification information (article ID) for identifying an article(s), which can be currently supplied from the article supply device(s) 1; arrangement information which relates to arrangement of the article supply devices 1 in the sales area; stock quantity information of the articles which can be currently supplied from the article supply device(s) 1; and article supply apparatus status information which indicates whether or not the discharge report of the article supply device 1 and the like is performed in a normal manner. In addition, the article supply device ID is provided as an attachment or printed on the article supply device 1.

The article information includes the article identification information (article ID) for identifying the article(s), the name of the article(s), information of an explanation of the article(s), an article explanation image and price information of the article(s). In addition, the article explanation image is the same as that printed on a paper sheet which is attached to the article supply device(s) 1 or that shown on a display of the article supply device(s) 1, so that the article to be supplied can be identified.

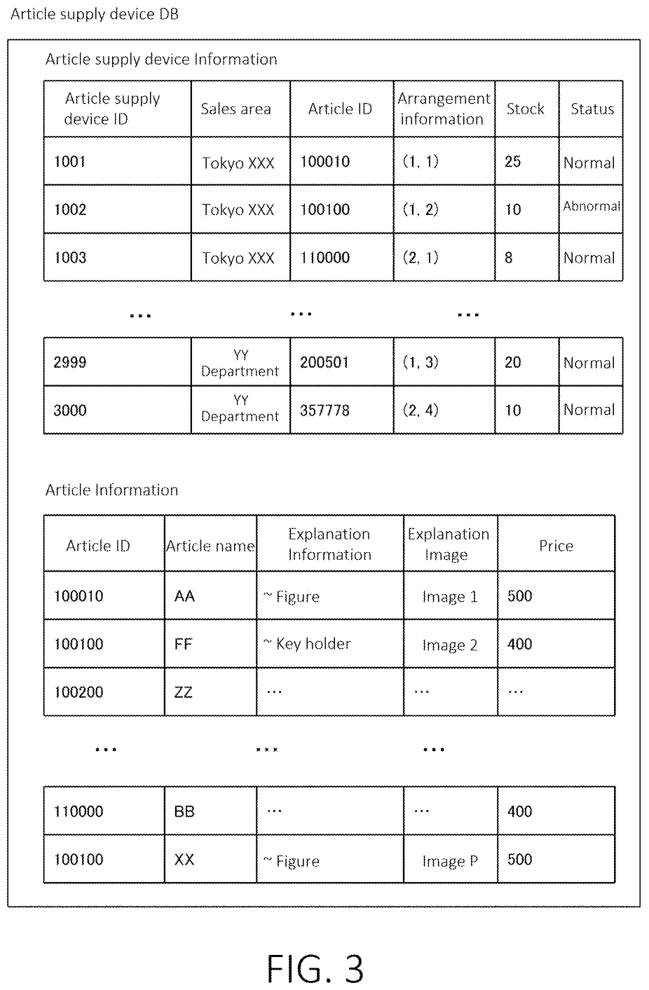

FIG. 3 shows an example of article supply device information and article information recorded in an article supply device database 4 (article supply device DB 4). In the example shown in FIG. 3, each of records in the article supply device information is made up of a field for an article supply device ID; a field for a sales area (store) for installation; a field for ID of an article(s) which can be currently supplied from the article supply device 1; arrangement information field which is information relating to arrangement of the article supply device 1 in the sales field; a field for a stock quantity information for the articles in the article supply device 1; and a field for status information of the article supply device 1. These pieces of the information are recorded so as to be associated with one another. For example, in the record of the article supply device ID “1001”, “1001” as the article supply device ID, “Tokyo XXX” as the sales area, “100010” as the article ID, (1, 1) as the arrangement information; “35” as the stock quantity and “Normal” as the status information are recorded so as to be associated with one another.

In the example shown in FIG. 3, each of records in the article information is made up of a field for an article ID, a field for an article name, a field for explanation information of the article(s), a field for an image for explanation of the article(s), and a field for price information of the article(s). These pieces of the information are recorded so as to be associated with one another. For example, in the record of the article ID “100010”, “100010” for the article ID, “AA” as a name of the article, “Figure” as the explanation information, “Image 1” as the explanation image and “¥500” as the price thereof are recorded so as to be associated with each other.

In addition, in the above-explained example, although the stock information in each article supply device is included in the article supply device information, since the stock information can be regarded as information relating to an article(s) to be supplied from each article supply device, the stock information may be included in the article information. These pieces of the information recorded in the article supply device database 4 are updated as needed by the management server 3.

### Configuration Example

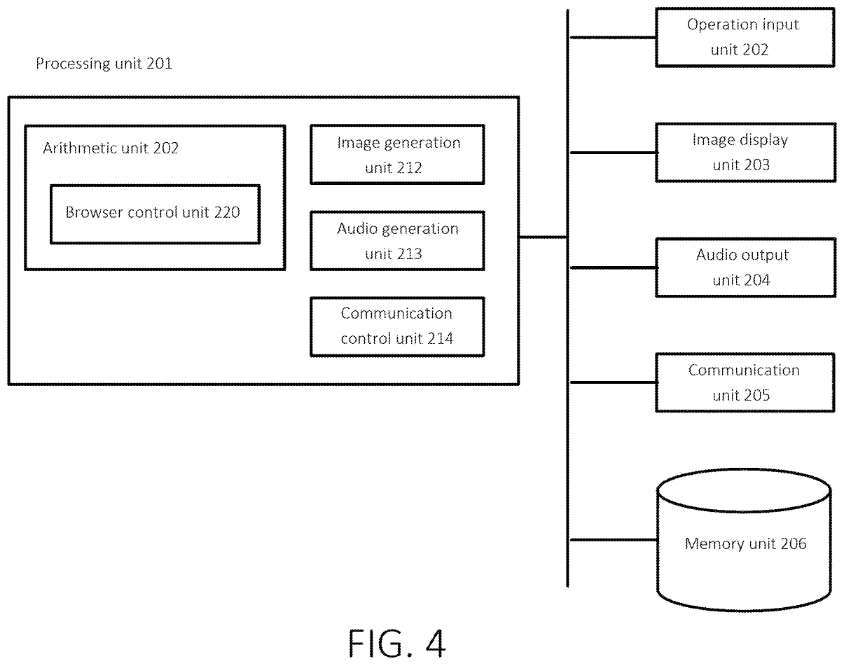

The configuration of the terminal 2 will be described below. FIG. 4 is a block diagram showing an example of a functional configuration of the terminal 2. As shown in FIG. 4, the terminal 2 is equipped with a processing unit 201, an operation input unit 202, an image display unit 203, and a sound output unit 204, a communication unit 205 and a memory unit 206.

The processing unit 201 integrally controls an operation of the terminal 2 based on the program and data stored in the memory unit 206 and an operation input signal etc. inputted from the operation input unit 202. Functions of the processing unit 201 can be achieved by, for example, a microprocessor, such as a CPU, a GPU, etc., and electronic components such as an ASIC and an IC memory etc. The processing unit 201 includes an arithmetic unit 211, an image generation unit 212, an audio generation unit 213 and a communication control unit 214, as main functional units.

The arithmetic unit 211 performs various processing in order to perform the functions of the terminal 2 and sends an output to the image generation unit 212, the audio generation unit 213 and the communication control unit 214. The arithmetic unit 211 includes a browser control unit 220.

The browser control unit 220 coverts HTML etc. acquired from the management server 3, into interactive documents by a layout engine of the web browser, and display it. When plug-ins corresponding to a flash application or Java applet are prepared, they can be displayed or performed.

The image generation unit 212 generates one image per one frame time (for example, 1/60 second) based on a processing result of the arithmetic unit 211, and outputs the generated image signal to the image display unit 203. Functions of the image generation unit 212 can be realized by, for example, a processor, such as a GPU, digital signal processor (DSP) etc., a video signal IC, a program for video codec etc., an IC memory for drawing frames such as a frame buffer etc., and an IC memory which is used for texture data development and the like.

Based on a processing result of the arithmetic unit 211, the audio generation unit 213 generates an audio signal(s) for a sound effect(s) and various operation sounds and the like, and outputs the audio signal(s) to the audio output unit 213. Functions of the audio generation unit 213 can be realized by, for example, a processor such as a digital signal processor (DSP), an audio synthesis IC, etc., and an audio codec capable of reproducing an audio file and the like. The communication control unit 214 performs processing for communication connection with the management server 3 etc. for data communication, and data processing.

The operation input unit 202 is provided to input various operations performed by a user. The operation input unit 202 outputs an operation input signal which corresponds to the operation input, to the processing unit 201. Functions of the operation input unit 202 can be realized by an element directly manipulated by a finger of the user, such as a touch operation pad, a home button, a button switch, a joystick, a trackball, etc. Also the functions of the operation input unit 301 can be realized by an element, which detects motion or posture, such as an acceleration sensor, an angular velocity sensor, an inclination sensor, and a geomagnetic sensor, etc. In FIG. 2, the touch operation panel 22 corresponds thereto.

The image display unit 203 displays a screen image based on an image signal inputted from the image generation unit 212. For example, functions of the image display unit 203 can be realized by a display device, such as a flat panel display, a cathode ray tube (CRT), a projector, a head-mounted display, etc. In FIG. 2, the image display unit 304 corresponds to the display 21.

The audio output unit 204 outputs sounds such as sound effects or the like, based on an audio signal inputted from the audio generation unit 213. For example, the audio output unit 204 corresponds to a speaker.

The communication unit 205 achieves communication by connecting with a communication line N. Functions of the communication unit 205 can be realized by, for example, a wireless communication device, a modem, a TA (terminal adapter), a jack and a control circuit of a communication cable for wired communication, and the like.

In the memory unit 206, programs for causing the terminal 2 to perform an operation and for realizing various functions provided in the terminal 2, and data etc. used during running of the programs are stored in advance, or such programs and data are temporarily stored therein every time each processing is performed. The memory unit 206 can be realized by, for example, an IC memory such as a RAM, a ROM, a flash memory, etc., a magnetic disk such as a hard disk etc., or an optical disc such as a CD-ROM, a DVD, etc. Specifically, in the memory unit 206, a system program and a control program for controlling a plaza etc. are stored. The system program realizes a basic function of the terminal 2 as a computer. The control program causes the arithmetic unit 211 to function as the browser control unit 220.

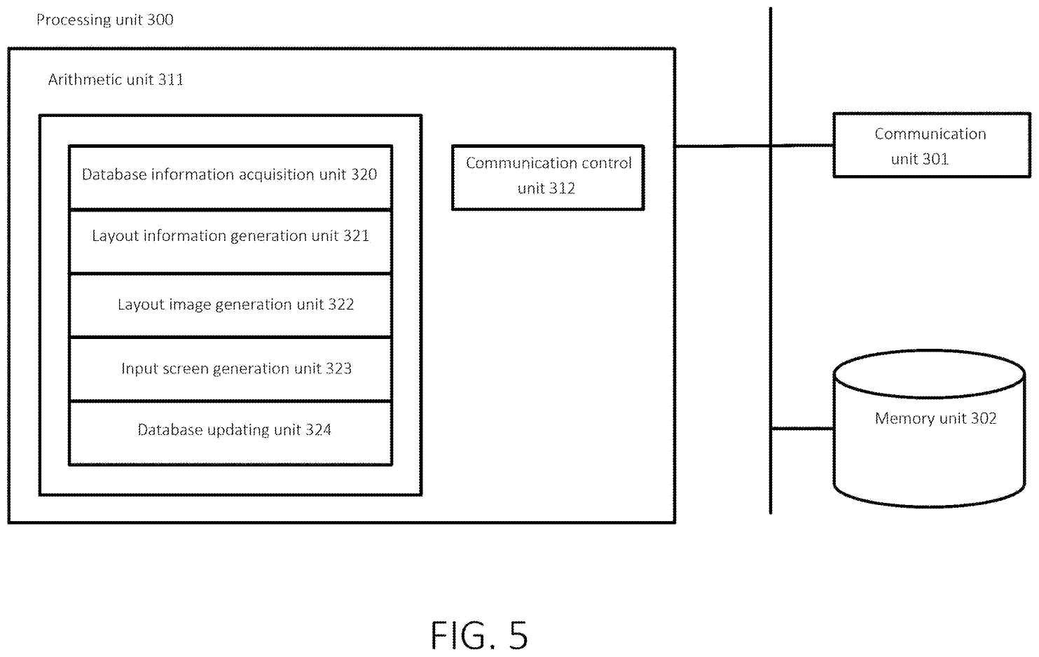

Next, the configuration of the management server 3 will be explained. FIG. 5 is a block diagram showing a functional configuration of the management server 3. As shown in FIG. 5, the management server 3 is equipped with a processing unit 300, a communication unit 301 and a memory unit 302.

The processing unit 300 integrally controls the operation of the management server 3 based on programs and data stored in the memory unit 303. Functions of the processing unit 300 can be achieved by, for example, a microprocessor such as a CPU, a GPU, etc., and electronic components such as an ASIC and an IC memory etc. The processing unit 300 includes an arithmetic unit 311 and a communication control unit 312, as main function parts.

The arithmetic unit 311 is equipped with a database information acquisition unit 320, a layout information generation unit 321, a layout image generation unit 322, an input screen generation unit 323, and a database updating unit 324.

The database information acquisition unit 320 acquires article supply device information in a record, which includes the sales area designated by the terminal 2, from the article supply device database 4, and acquires the article information in a record including the article ID, which is included in the article supply device information in each of acquired records.

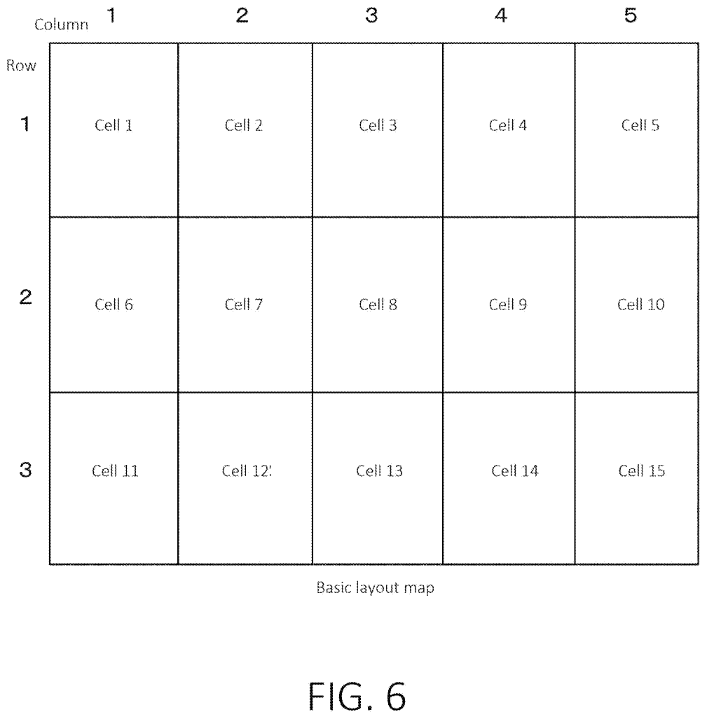

The layout information generation unit 321 generates layout information required for generation of a layout image. Normally, two or three article supply devices 1 are vertically stacked in a layout of a sales area, and two or more sets of these stacked article supply devices 1 are arranged in a transverse direction. Taking such a layout into consideration, the layout information generation unit 321 stores in advance a basic layout map for generation of the layout information. FIG. 6 shows an example of a basic layout map. In the example shown in FIG. 6, the basic layout map is made up of fifteen cells, and the position of each cell corresponds to the position of each of the article supply devices 1 arranged in the sales area. The position of each cell of the basic layout map can be identified by a coordinate point based on a row and a column. For example, the coordinate of a cell 1 is (1, 1). This cell coordinate is the arrangement information included in the article supply device information.

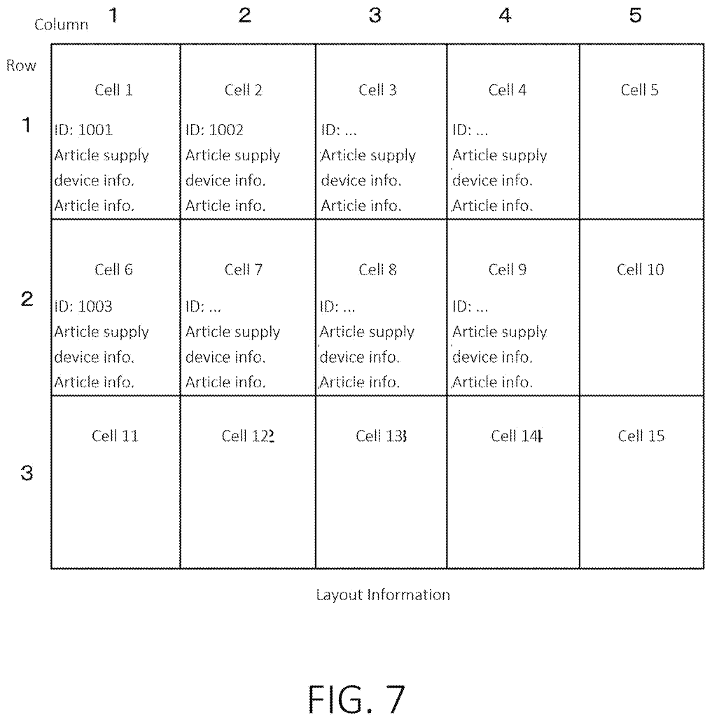

The layout information generation unit 321 adds each piece of article supply device information and each piece of article information in the sales area acquired by the database information acquisition unit 320, to a cell of the basic layout map by using the arrangement information of each pieces of the article supply device information. FIG. 7 shows a diagram showing an example in which each piece of the article supply device information and each piece of the article information are arranged in the basic layout map. In FIG. 7, article supply device information and article information which corresponds to an article supply device 1 having arrangement information “(1, 1)” is added to the cell at a coordinate (1, 1) of the basic layout map, and article supply device information and article information which corresponds to an article supply device 1 having arrangement information “(1, 2)” is added to the cell at a coordinate (1, 2) of the basic layout map. And similarly, article supply device information and article information is respectively given to each of other cells. In addition, cells to which article supply device information and article information is not given are cells where no article supply device is arranged at positions corresponding to these cells.

The layout information generation unit 321 generates such layout information of the sales area in this manner. The layout information generation unit 321 assigns layout information identification information (layout information ID) for uniquely identifying the layout information to the generated layout information and stores the layout information ID and the layout information.

The layout image generation unit 322 generates a layout image of the sales area by using the layout information. Generation of such a layout image of the sales area will be explained. The layout image generation unit 322 generates object images of article supply devices 1 installed in the sales area. Such an object image is generated by using article supply device information and article information of each cell in the layout information. Specifically, an explanation image, price information and stock quantity information acquired from the article supply device information and the article information of a cell is superimposed on the image in a predetermined size which simulates an article supply device 1 thereby generating an object image corresponding to each article supply device 1.

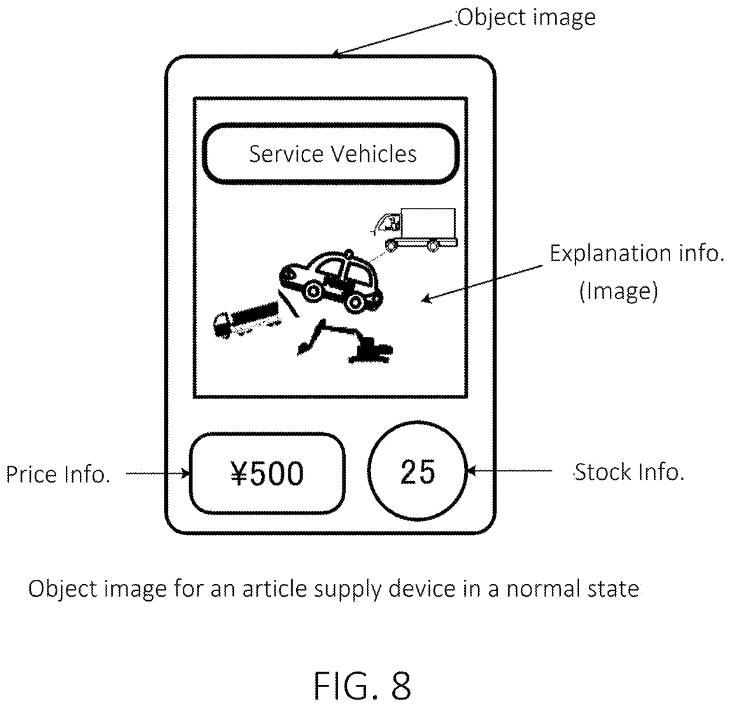

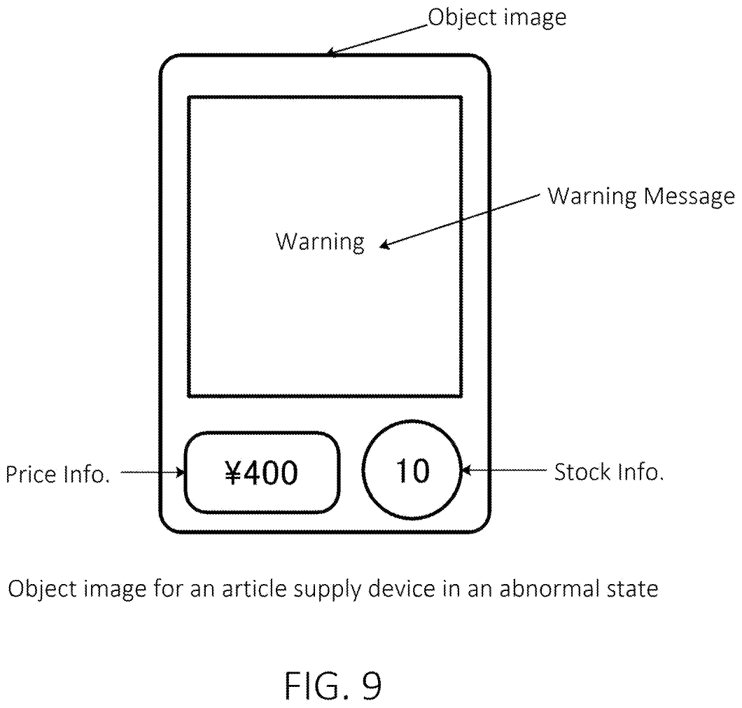

FIG. 8 is a diagram showing an example of the object image. In the example shown in FIG. 8, the object image for the cell at (1, 1) corresponds to an article supply device ID “1001” in case where status information of the article supply device ID “1001” is normal, wherein the explanation image, imaged price information (¥500) and stock quantity (25) are superimposed on the image which simulates the article supply device 1, and which is prepared in advance. FIG. 9 is a diagram showing an example of an object image for the cell (1, 2) which corresponds to an article supply device ID “1002” in case where status information of the article supply device ID “1002” is abnormal. In the example, instead of such an explanation image, an image for warning information (error information), imaged price information (¥500) and stock quantity (10) are superimposed on an image, which simulates the article supply device 1, and which is prepared in advance. Further, in case where the stock quantity is zero, that is, the number of articles which can be supplied is zero, instead of such an explanation image, an image for warning information may be superimposed thereon. In addition, preferably the image for warning information (error information) may be differently expressed so that the image for warning information can be distinguished from the object image of the other article supply devices in a normal state. That is, it may be different in color (red) from the object images of the article supply devices.

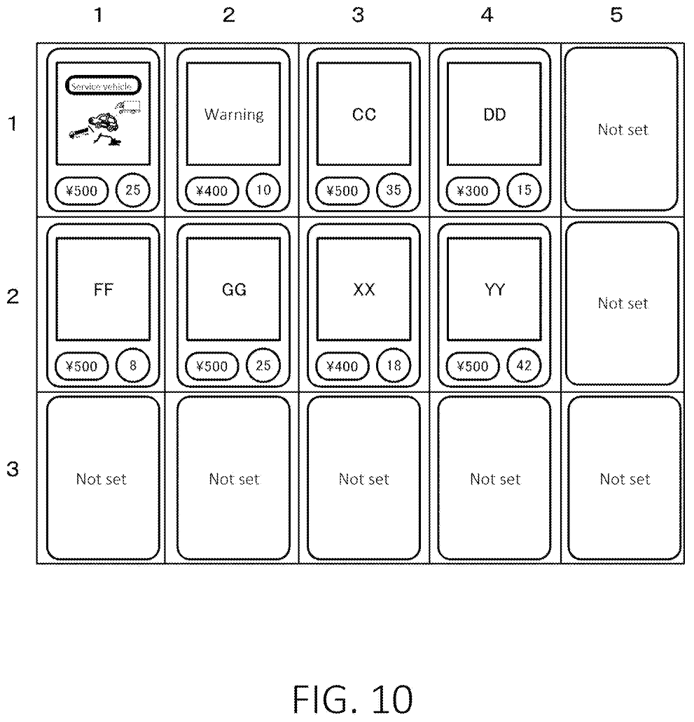

The layout image generation unit 322 arranges the generated object image of each cell on the basic layout map, and shows information indicating that no article supply device 1 is set on cells where article supply device information and article information is not arranged. The layout image generation unit 322 generates the layout image in such a manner. FIG. 10 is a diagram showing an example of a layout image. This layout image corresponds to a layout information, which includes a coordinate of each cell where an object image is arranged. When an object image is selected on the terminal 2, article supply device information and article information of an article supply device 1 corresponding to the coordinate of the cell of the selected object image can be acquired from the corresponding layout information. The layout image generation unit 322 transmits the generated layout image, the layout information and layout information ID to the terminal 2.

The input screen generation unit 323 generates a screen for each processing required to perform a management operation such as replenishment of articles to be supplied by an article supply device 1, replacement of articles to be supplied by an article supply device 1, new installation of an article supply device 1, and removal of an installed article supply device 1. And the input screen generation unit 323 transmits each of the images therefor to the terminal 2.

The database updating unit 324 updates the article supply device information and the article information of the article supply device database 4 by using stock information, which is transmitted from the article supply device 1, and the article supply device information and the article information of the article supply device 1, which is transmitted from the terminal 2

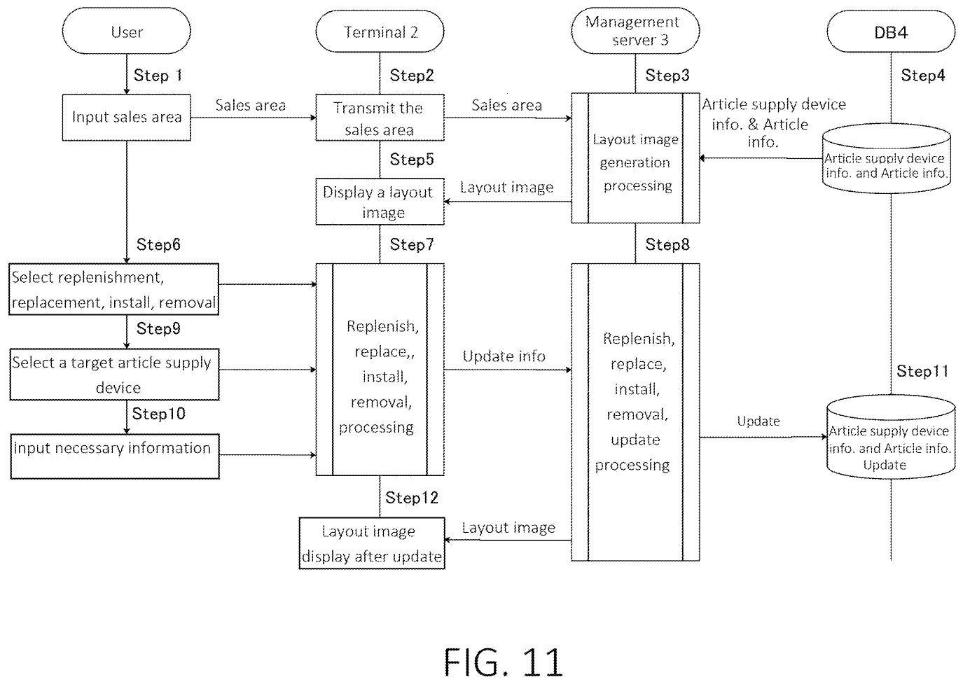

Next, an operation of the management system according to the present embodiment will be explained below. FIG. 11 is a sequence diagram of the entire management system.

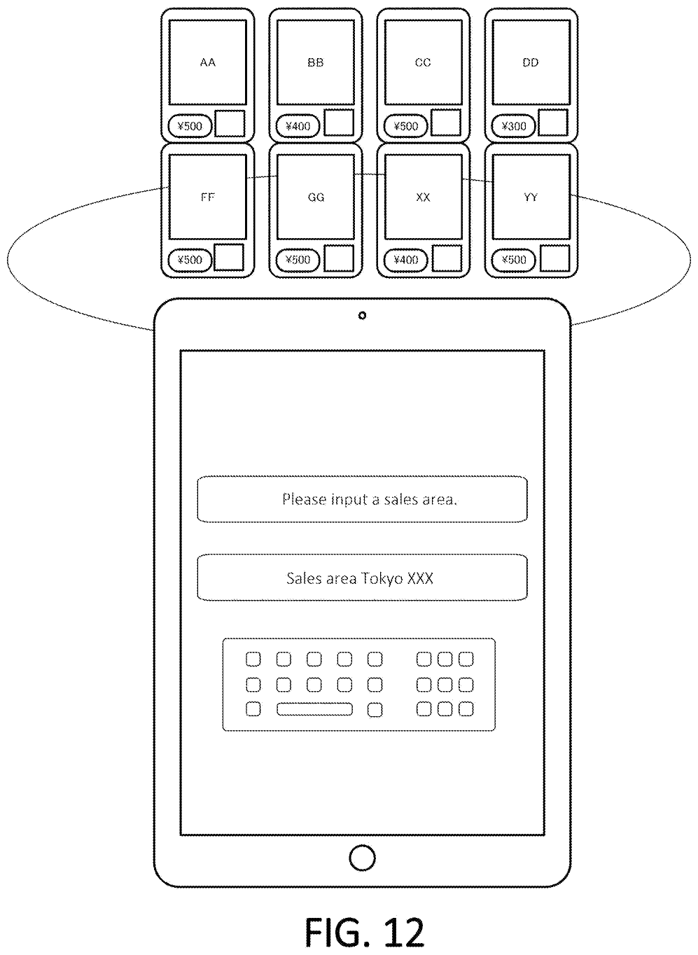

A user who visits a sales area where article supply devices 1 are installed, inputs the sales area where he or she visits, on an initial screen of a terminal 2 (Step 1). In this example, as shown in FIG. 12, the user inputs “Tokyo XXX” as the sales area. The browser control unit 220 of the terminal 2 transmits the inputted information of the sales area “Tokyo XXX” to the management server 3 (Step 2).

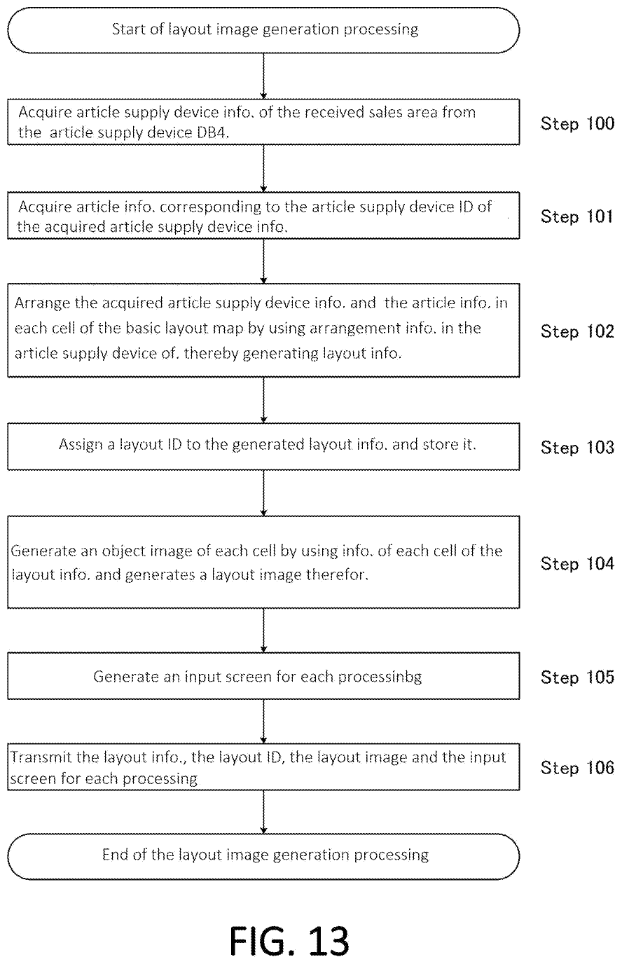

The management server 3 receives the information of the sales area and performs layout image generation processing (Step 3). The layout image generation processing performed by the management server 3 will be described. FIG. 13 is a flowchart of the layout image generation processing.

The database information acquisition unit 320 of the management server 3 acquires the article supply device information in a record including the designated sales area, from the article supply device database 4 (Step 100). In this example, the article supply device information, in which the sales area is “Tokyo XXX”, is acquired from the article supply device database 4. For example, the article supply device information is an article supply device ID “1001” etc.

Next, the database information acquisition unit 320 of the management server 3 acquires article information in a record including an article ID, which is included in the article supply device information of each of the acquired records (Step 101). For example, since the article ID of the article supply device ID “1001” is “100010”, the article information of the article ID “100010” is acquired from the article supply device database 4.

The layout information generation unit 321 of the management server 3 arranges the article supply device information and the article information, which is acquired by the database acquisition unit 320, on each cell of the basic layout map, by using arrangement information of the article supply device information, thereby generating the layout information of the sales area (Step 102). In this example, the layout information shown in FIG. 7 is generated.

The layout information generation unit 321 of the management server 3 assigns layout information identification information (a layout information ID) for uniquely identifying the layout information, to the generated layout information, and stores the layout information ID and the layout information (Step 103).

The layout image generation unit 322 of the management server 3 generates an object image, by using the article supply device information and the article information of each cell in the layout information. And the layout image generation unit 322 generates a layout image by arranging the object image, to a cell in the basic layout map, which corresponds to the object image, and by adding information indicating that no article supply device 1 is set, to a cell(s) where article supply device information and article information is not arranged (Step 104).

The input screen generation unit 323 of the management server 3 generates a screen for processing required to perform each of the management operations such as replenishment of articles to be supplied by an article supply device 1, replacement of articles to be supplied by an article supply device 1, new installation of an article supply device 1, and removal of an installed article supply device 1 (Step 105).

The management server 3 transmits the layout information of the sales area, the layout ID, the layout image and each of the input screens, to the terminal 2 (Step 106).

Explanation will continue, referring back to the sequence diagram shown in FIG. 11.

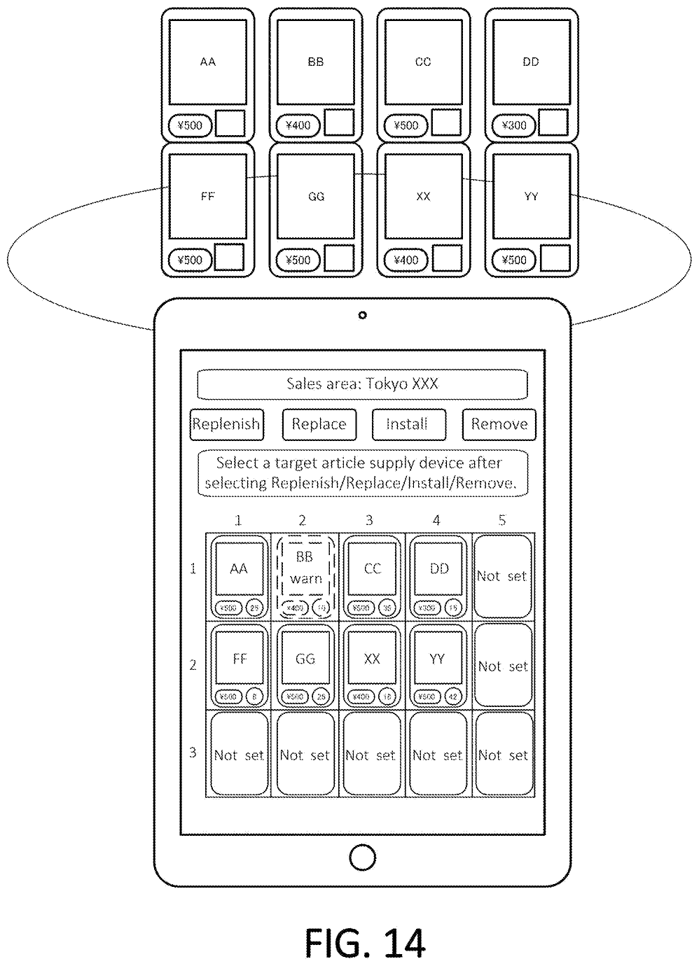

The browser control unit 220 of the terminal 2 receives the layout information of the sales area, the layout ID, the layout image and each of the input screens, and displays the layout image of the sales area (Step 5). FIG. 14 is a diagram showing an example of the layout image displayed on the terminal 2. In the layout image displayed on the terminal 2, object images corresponding to respective article supply devices 1 are arranged in the same layout as that of the article supply devices 1 which are actually installed in the sales area. Further, each of the object images includes the same image as that shown on a paper sheet attached to the article supply device 1 installed in the sales area, or an image of article explanation displayed on a display. Furthermore, the object image includes the price and stock quantity. Since the user who visits the sales area can identify an article supply device without hesitation and grasp the status thereof from such a layout image, the efficiency of work such as replenishment etc. can be enhanced.

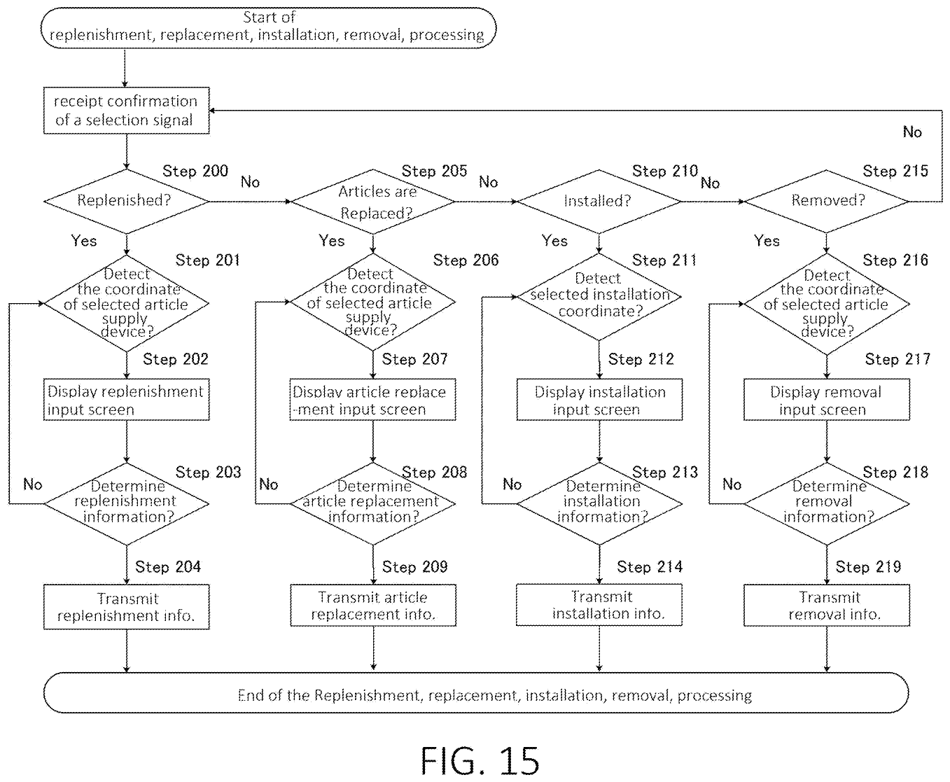

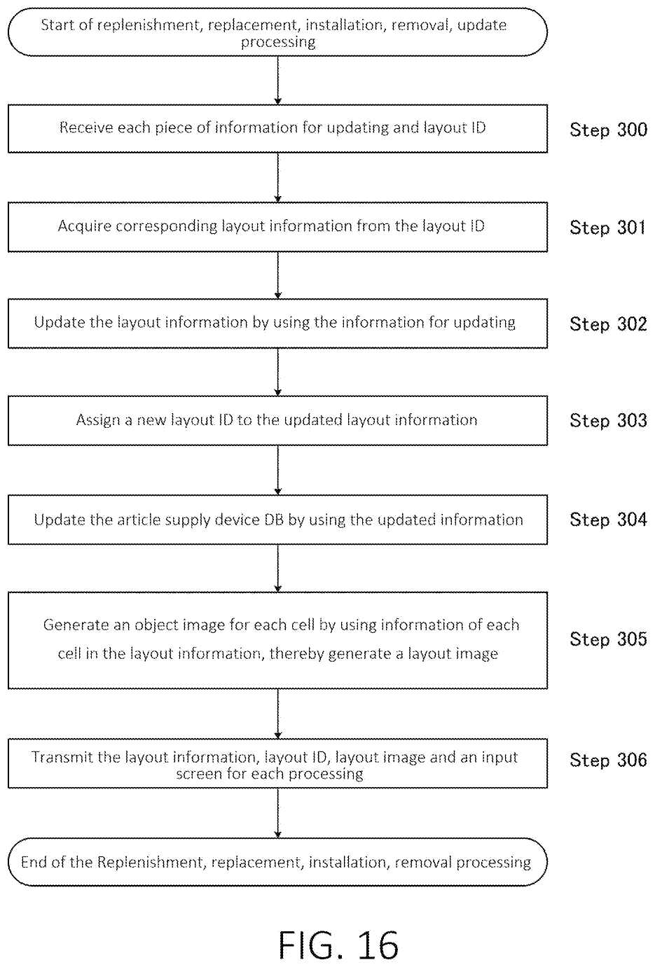

Next, the user performs a replenishment of articles, replacement thereof, new installation of an article supply device(s), or removal of article supply device 1, in the sales area. These operations are performed in replenishment, replacement, installation or removal processing in the terminal 2 (Step 7) and in replenishment, replacement, installation, or removal and update processing in the management server 3 (Step 8). FIG. 15 is a flowchart of the replenishment, replacement, installation; and removal processing (Step 7). FIG. 16 is a flowchart of the replenishment, replacement, installation, or removal and update processing in the management server 3 (Step 8). An operation of each work will be described referring to the flowcharts.

1. Processing for Replenishment of Articles to be Supplied from Article Supply Device First, an Operation of the Terminal 2 Will be Explained.

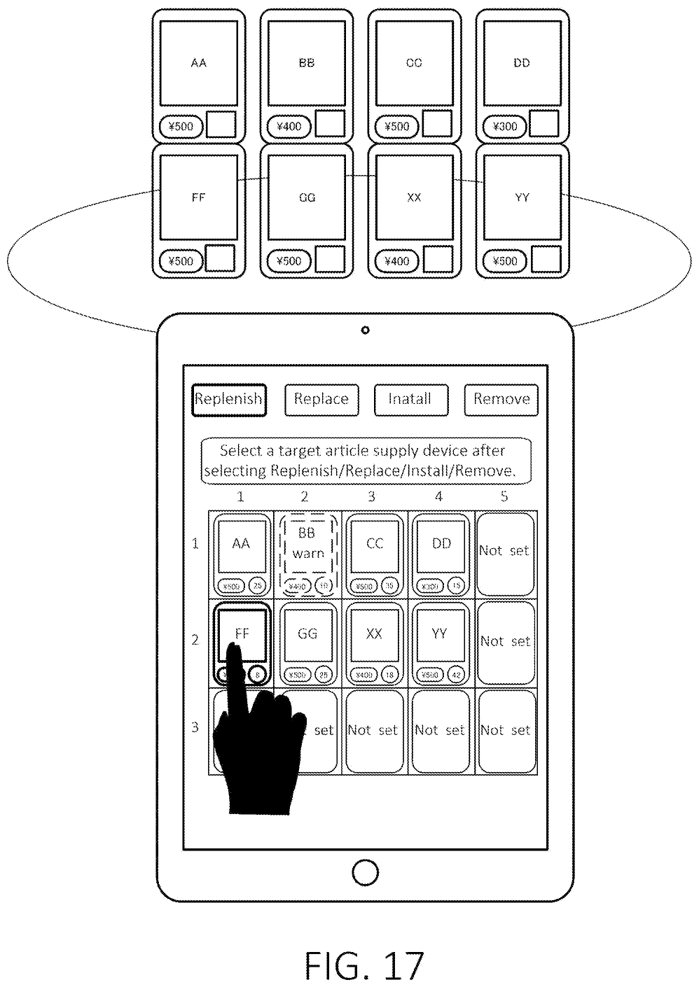

The user selects a replenishment tab of the terminal 2 (Step 6), and selects an object image at position corresponding to the article supply device 1 which is a target device for the replenishment of the articles. FIG. 17 is a diagram showing an example of an operation of the terminal 2 in case of the article replenishment. In the example shown in FIG. 17, the replenishment tab is selected, and the article supply device of a cell at a coordinate (2, 1) is selected as the target for the replenishment of the articles.

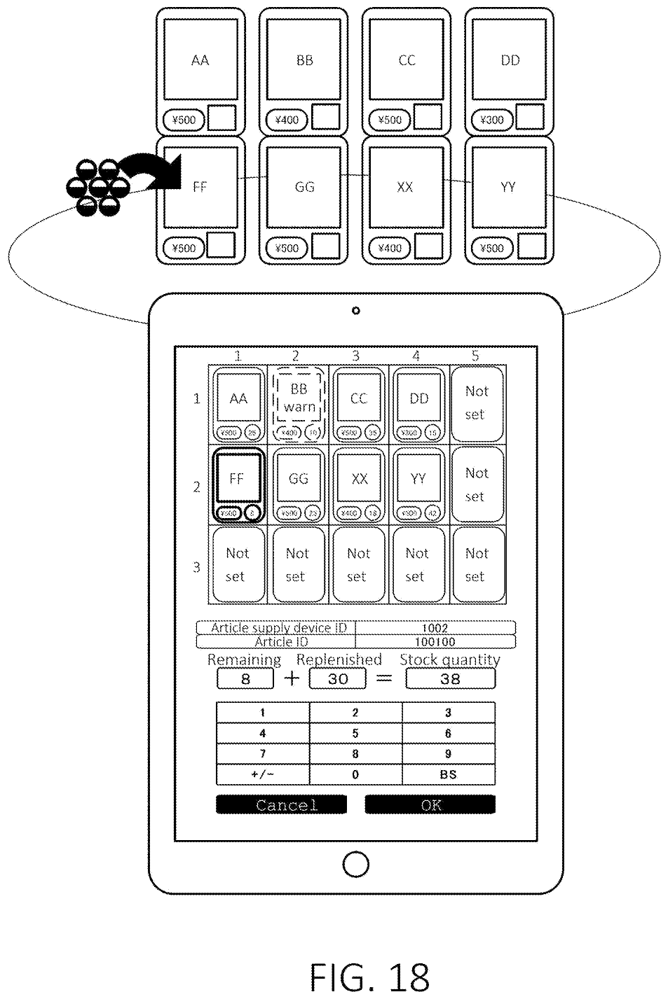

The browser control unit 220 of the terminal 2 detects the coordinate of the cell of the selected object image (Step 201) when a replenishment tab is selected (Step 200), and when an object image of an article supply device is selected on a layout image. When the coordinate of the cell is detected, it displays an input screen for “replenishment” which is the selected processing details (Step 202). FIG. 18 is a diagram showing an example of an input screen for the “replenishment”. As shown in FIG. 18, an article supply ID of the article supply device corresponding to the cell at the coordinate (2, 1), an article ID of an articles which are supplied by the article supply device, and the stock quantity (remaining) of the articles are read out from the layout information and are displayed on the input screen for the “replenishment”.

After the user ends the operation for inputting the replenishment information (the replenishment number) (by inputting the replenishment number “30” in FIG. 18), “OK” is clicked (Step 203), the browser control unit 220 of the terminal 2 transmits the replenishment information (the coordinate of the selected cell, the stock quantity after the replenishment, and the layout ID) to the management server 3 (Step 204).

Next, an operation on the management server 3 will be described below. The management server 3 receives the replenishment information which is the information for updating (the coordinate of the selected cell, the stock quantity after the replenishment and the layout ID) (Step 300).

The layout information generation unit 321 of the management server 3 acquires the layout information corresponding to the received layout ID, from the recorded layout information (Step 301). The layout information generation unit 321 updates the information of the stock quantity for the article supply device ID corresponding to the received cell coordinate in the layout information, to the received stock quantity after the replenishment is done (Step 302). And the layout information generation unit 321 assigns a new layout ID to the updated layout information and stores it (Step 303).

The database updating unit 324 of the management server 3 updates the information of the stock quantity of the article supply device ID, for which the layout information has been updated, to the stock quantity after replenishment, in the article supply device database 4 (Step 304).

The layout image generation unit 322 of the management unit 3 generates an object image by using the article supply device information and the article information of each cell in the updated layout information. And the object images are arranged to the cells on the basic layout map, which respectively correspond to the object images, and information indicating no article supply device 1 is set, is added to a cell(s) in which article supply device information and article information is arranged, thereby generating the layout image (Step 305). In addition, only object images for cells in which the article supply device information and the article information is updated may be newly generated, and object images for the other cells may be reused.

The management server 3 transmits the layout information of the sales area, the layout ID, the layout image and each of the input screen to the terminal 2 (Step 306).

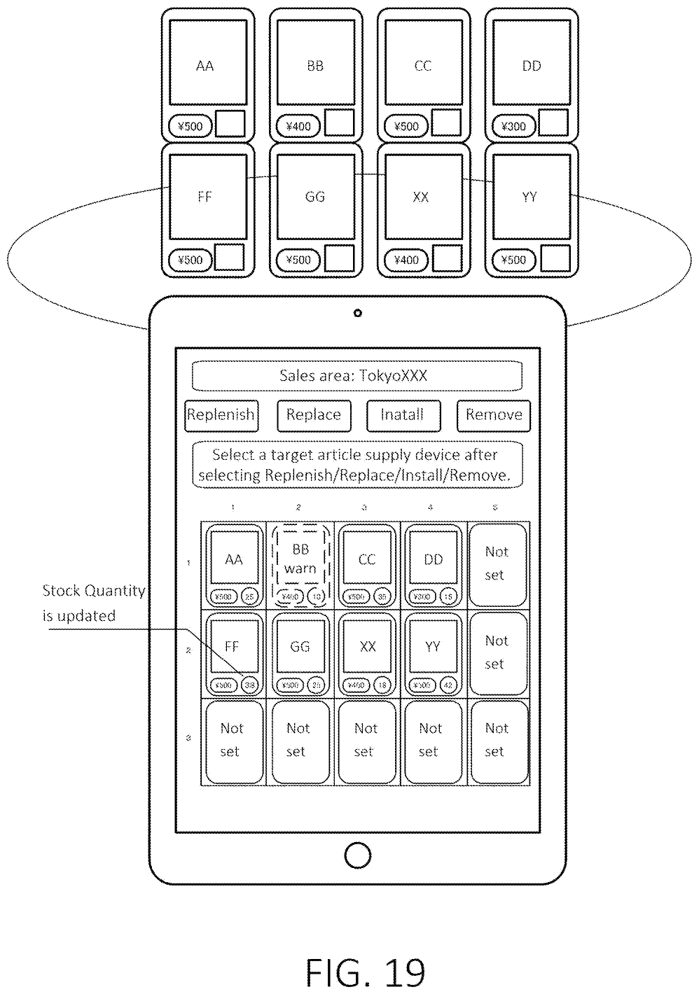

The terminal 2 receives the layout information of the sales area, the layout ID, the layout image and each of the input screens, and displays the updated layout image (Step 12). FIG. 19 is a diagram showing an example of the layout image after the information of the stock quantity of the selected article supply device is updated. In FIG. 19, the stock quantity of the article supply device corresponding to the cell at the coordinate (2, 1) has been updated. Thus, the operation of the processing for replenishing articles to the article supply device 1 is completed.

2. Processing for Replacement of Articles in the Article Supply Device 1.

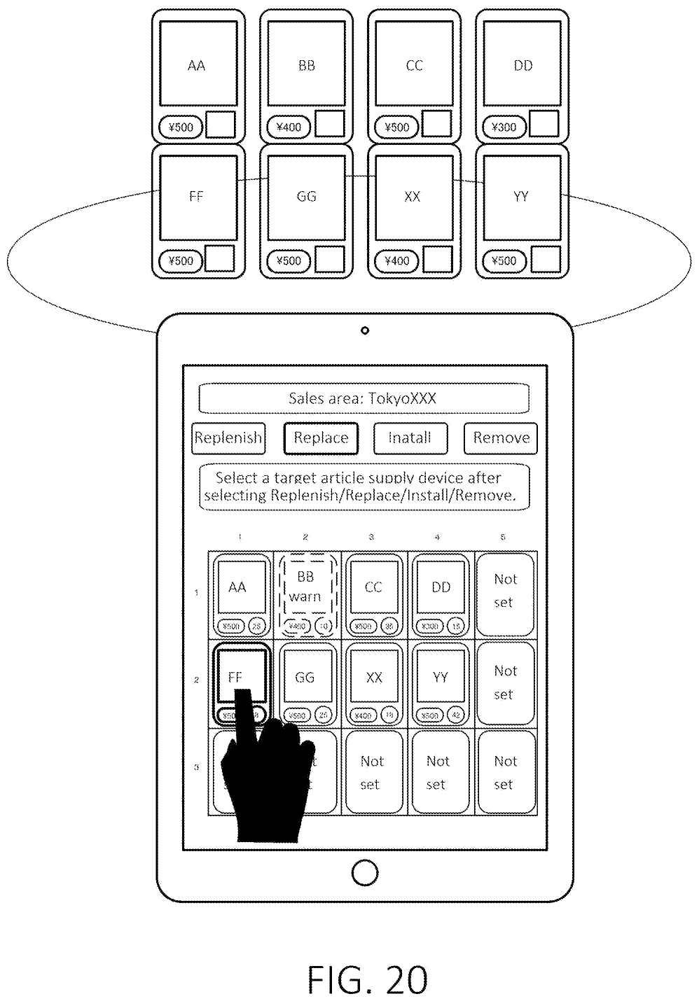

First, the user selects an article replacement tab of the terminal 2 (Step 6), and selects an object image at a position corresponding to the article supply device 1, which is a target for the replacement of the articles. FIG. 20 is a diagram showing an example of an operation of the terminal 2 in case of the article replenishment. In the example shown in FIG. 20, article replacement is selected, and the article supply device of a cell at (2, 1) is selected as an object of the replacement.

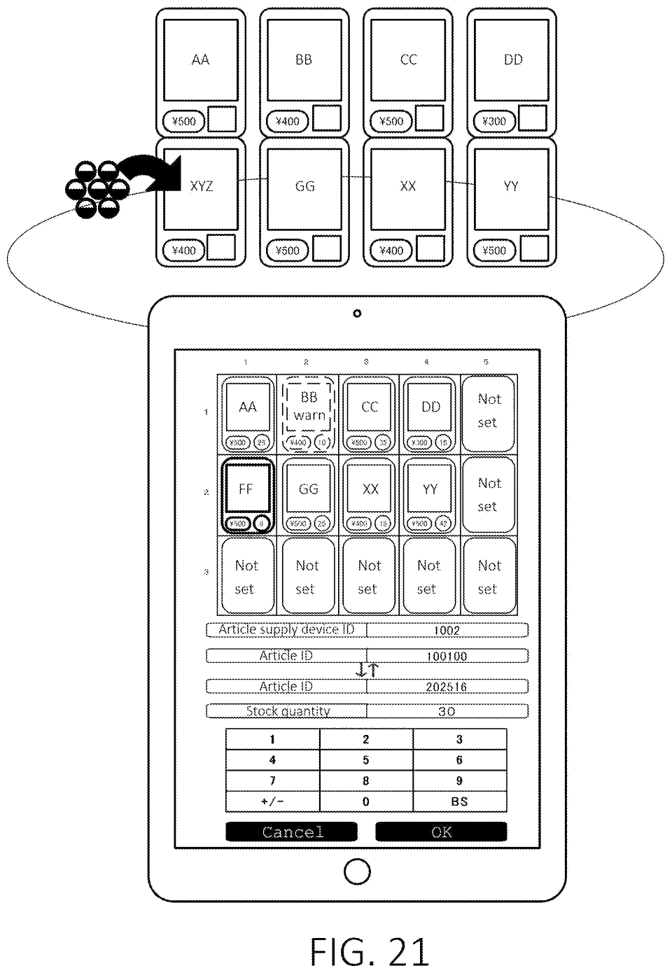

The browser control unit 220 of the terminal 2 detects the coordinate of the cell of the selected object image (Step 206), when the article replacement tab is selected (Step 205), and the object image of the article supply device is selected on the layout image. When the coordinate of the cell is detected, an input screen for “Article Replacement”, which is the selected processing details is displayed (Step 207). FIG. 21 is a diagram showing an example of the input screen for the “Article Replacement.” The article supply device ID of the article supply device corresponding to the cell at the coordinate (2, 1) and the article ID of the articles to be supplied are read out from the layout information and displayed on the input screen for the “Article Replacement” shown in FIG. 21. In addition, an article replacement inputting screen for inputting the article ID of the articles to be replaced by the user and the stock quantity is displayed.

When the input of the article replacement information is completed (by inputting the article ID “202516” and the stock quantity “30” in FIG. 21) and OK is clicked (Step 208), the browser control unit 220 of the terminal 2 transmits article replacement information (the selected cell coordinate, article ID of the articles to be replaced, the stock quantity and the layout ID to the management server 3 (Step 209).

Next, an operation on a side of the management server is explained. The management server 3 receives the article replacement information which is information for updating (the coordinate of the selected cell, the article ID of the articles to be replaced, the stock quantity and the layout ID) (Step 300).

The layout information generation unit 321 of the management server 3 acquires layout information corresponding to the received layout ID from recorded layout information (Step 301). The layout information generation unit 321 updates the article ID for the article supply device ID corresponding to the received coordinate of the cell and the stock quantity in the layout information, to the received article ID and the stock quantity, thereby updating the layout information (Step 302). And the layout information generation unit 321 assigns a new layout ID to the updated layout information and store it (Step 302).

The database updating unit 324 of the management server 3 updates the information of the article ID of the article supply device ID for which the layout information is updated and the stock quantity, to the article ID and the stock quantity of the updated layout information (Step 304).

The layout image generation unit 322 of the management server 3 generates an object image by using the article supply device information and the article information of each cell of the updated layout information. And the object image is arranged in the cell of the basic layout map corresponding to the object image, and information indicating that no article supply device 1 is set is shown in a cell(s) where article supply device information and article information is not arranged, thereby generating a layout image (Step 305). In addition, only object images for cells in which the article supply device information and the article information is updated may be newly generated, and object images for the other cells may be reused.

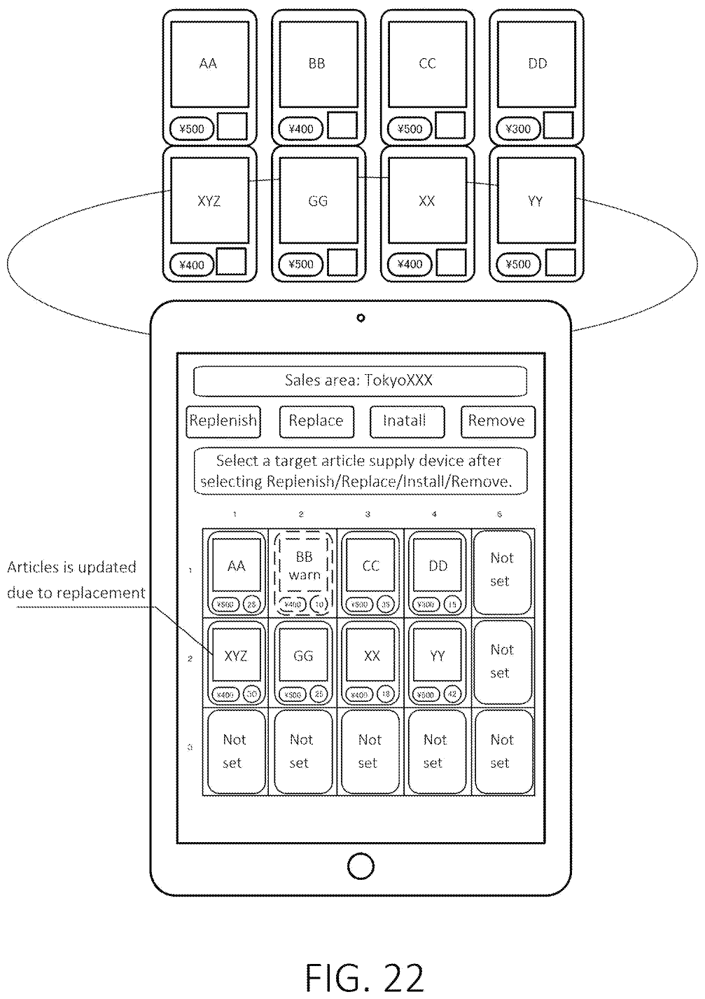

The management server 3 transmits the layout information of the sales area, the layout ID, the layout image and each of the input screens to the terminal 2 (Step 306). The terminal 2 receives the layout information of the sales area, the layout ID, the layout image and each input screen, and displays the updated layout image (Step 12). FIG. 22 is a diagram showing an example of a layout image after the article ID supplied by the selected article supply device and stock quantity thereof are updated. In FIG. 22, the articles (goods) supplied from the article supply device corresponding to the cell at the coordinate (2, 1) are replaced, so that explanation image in the object image of the cell at the coordinate (2, 1), the price and the stock quantity have been updated. Thus, the operation of the processing for replacing articles of the article supply device 1 is completed.

3. Processing for New Installation of an Article Supply Device 1

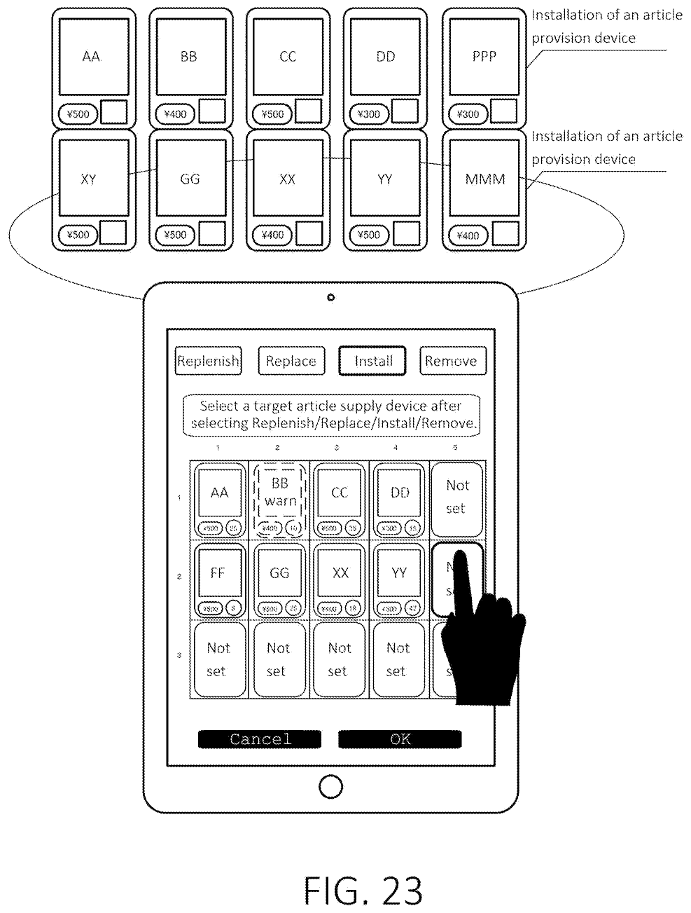

First, the user selects an installation tab of the terminal 2 (Step 6), and selects a cell (a cell for which no setting is made) corresponding to a position where the article supply device 1 should be newly installed. FIG. 23 is a diagram showing an example of an operation of the terminal 2 in case of the installation of the new article supply device 1. In the example shown in FIG. 23, a cell at a coordinate (2, 5) corresponding to a position where the new article supply device 1 is newly installed, is selected.

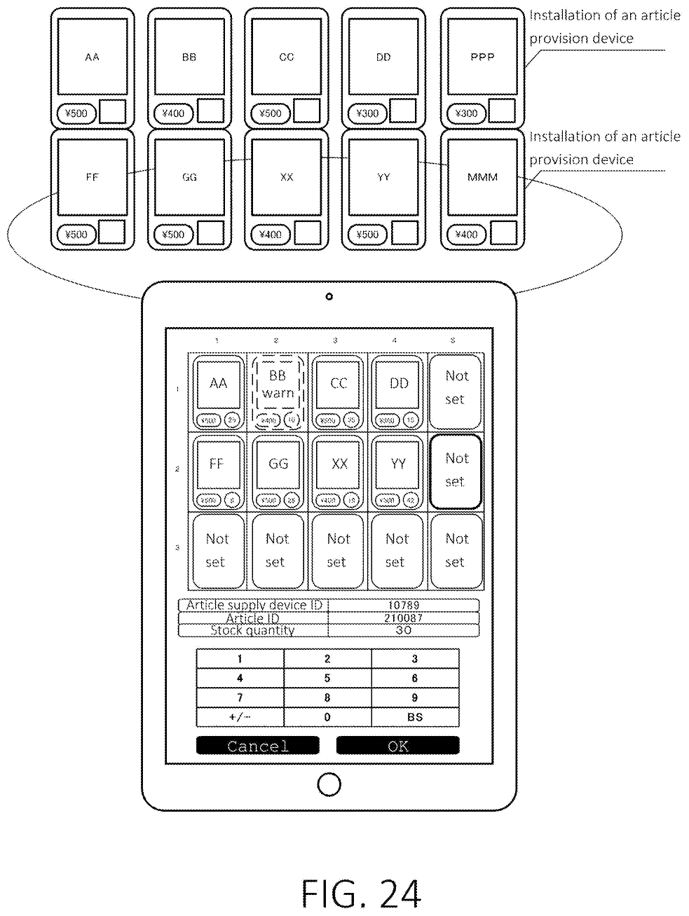

When an installation tab is selected (Step 210), and a cell for which no setting is made is selected on the layout image, the browser control unit 220 of the terminal 2 detects a coordinate of the selected cell (Step 211). When the coordinate of the cell is detected, an input screen for “installation” which is the selected processing details is displayed (Step 212). FIG. 24 is a diagram of an example of an input screen for the “installation”. On the input screen for the “installation” shown in FIG. 24, the article supply device ID of the article supply device arranged at a position corresponding to the selected cell, the article ID of articles to be supplied therefrom, and the stock quantity thereof are displayed.

When the input operation of the arrangement information is completed (by inputting the article supply device ID “10789”, the article ID “210087” and the stock quantity “30” in FIG. 24) and OK is pressed (Step 213), the browser control unit 220 of the terminal 2 transmits installation information (the coordinate of the selected cell, the article supply device ID to be installed, the article ID, the stock quantity thereof and the layout ID) to the management server 3 (Step 214).

Next, an operation on the side of the management server will be explained. The management server 3 receives the installation information (the coordinate of the selected cell, the article supply device ID to be installed, the article ID, the stock quantity thereof and the layout ID) which is information for updating (S300).

The layout information generation unit 321 of the management server 3, acquires the layout information corresponding to the received layout ID from the recorded layout information (Step 301). By using the installation information (the coordinate of the selected cell, the article supply device ID to be arranged, the article ID, the stock quantity thereof, and the layout ID), the layout information generation unit 321 writes “the article supply device ID, the sales area, the article ID, arrangement information, the stock quantity and status” in the cell at the selected coordinate in the layout information, thereby updating the layout information Step 302). And the layout information generation unit 321 assigns a new layout ID to the updated layout information and store it (Step 303).

The database updating unit 324 of the management unit 3 records “the article supply device ID, the sales area, the article ID, the arrangement information, the stock quantity and the status” of the newly installed article supply device, in the article supply device database 4, thereby updating the article supply device database 4 (Step 304).

The layout image generation unit 322 of the management server 3 generates an object image by using the article supply device information and the article information of each cell in the updated layout information. And the object images are arranged in the respective cells corresponding thereto in the basic layout map, and information indicating that any article supply device is not set is displayed in a cell(s) where the article supply device information and the article information is not arranged, thereby generating a layout image (Step 305). In addition, only object images for cells in which the article supply device information and the article information is updated may be newly generated, and object images for the other cells may be reused. The management server 3 transmits the layout information of the sales area, the layout ID, the layout image and each of the input screens, to the terminal 2 (Step 306).

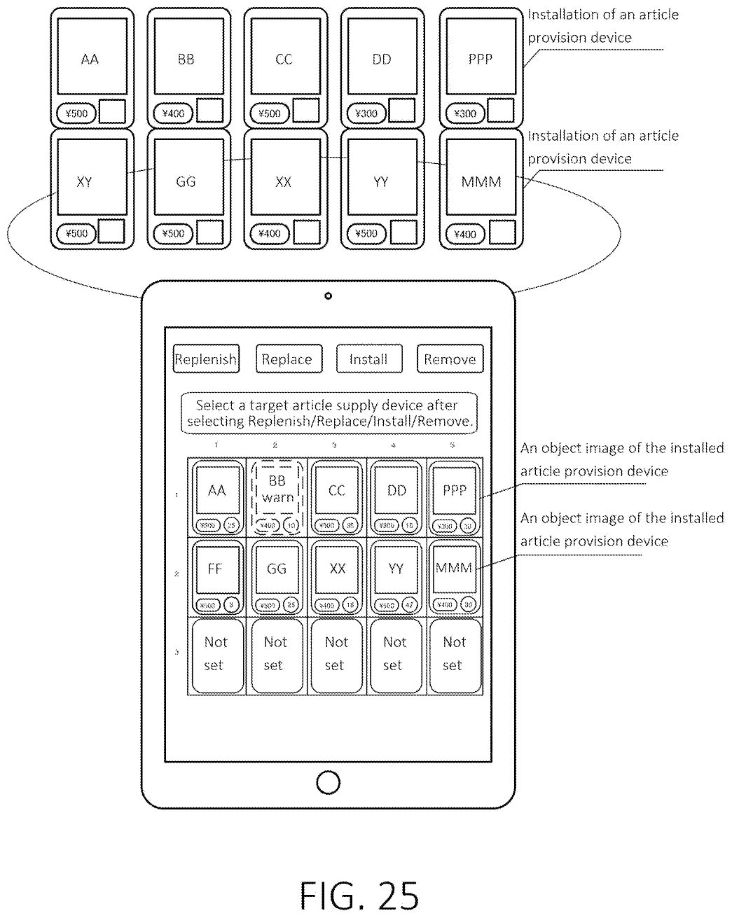

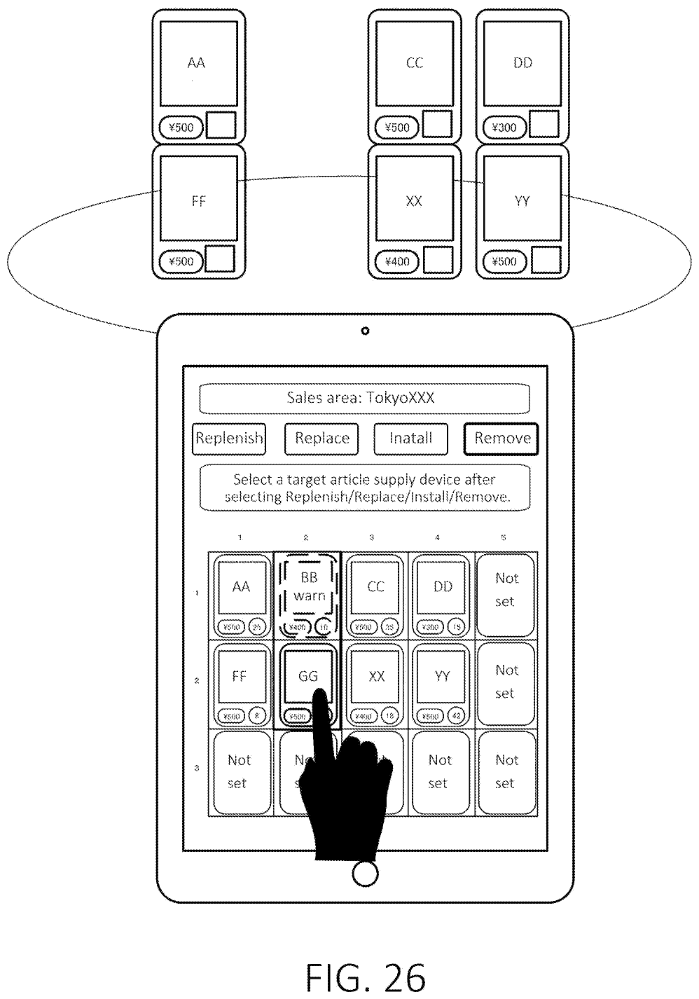

The terminal 2 receives the layout information of the sales area, the layout ID, the layout image and each of the input screens, and displays the updated layout image (Step 12). Processing similar thereto is performed about a cell at the newly installed coordinate (1, 5). FIG. 25 is a diagram showing an example of a layout image after the newly installed article supply device is updated. FIG. 25 shows the layout image in which the object images of the newly installed article supply device are respectively added to the cells at coordinates (1, 5) and (2, 5). Thus, the operation of the new installation of the article supply device 1 is completed. [0087] 4. Processing for removal of an article supply device First, the user selects a removal tab of the terminal 2 (Step 6), and selects a cell corresponding to a position of an article supply device 1 to be removed. In order to take a visual quality of arrangement of the article supply devices 1 into consideration, it may be often the case where two article supply devices 1, which are vertically arranged one above the other, are removed at the same time. Therefore, in the present embodiment, it is configured that when a cell corresponding to either one of two article supply devices 1, which are vertically arranged one above the other, is selected, the other cell is selected at the same time. FIG. 26 is a diagram showing an example of an operation of the terminal 2 in the case of removal of an article supply device(s) 1. In the example shown in FIG. 26, cells at coordinates (1, 2) and (2,2), which correspond to the two article supply devices 1 are selected, by selecting a cell at the coordinate (2, 2) which corresponds to one of the article supply devices 1 among the article supply devices 1 to be removed.

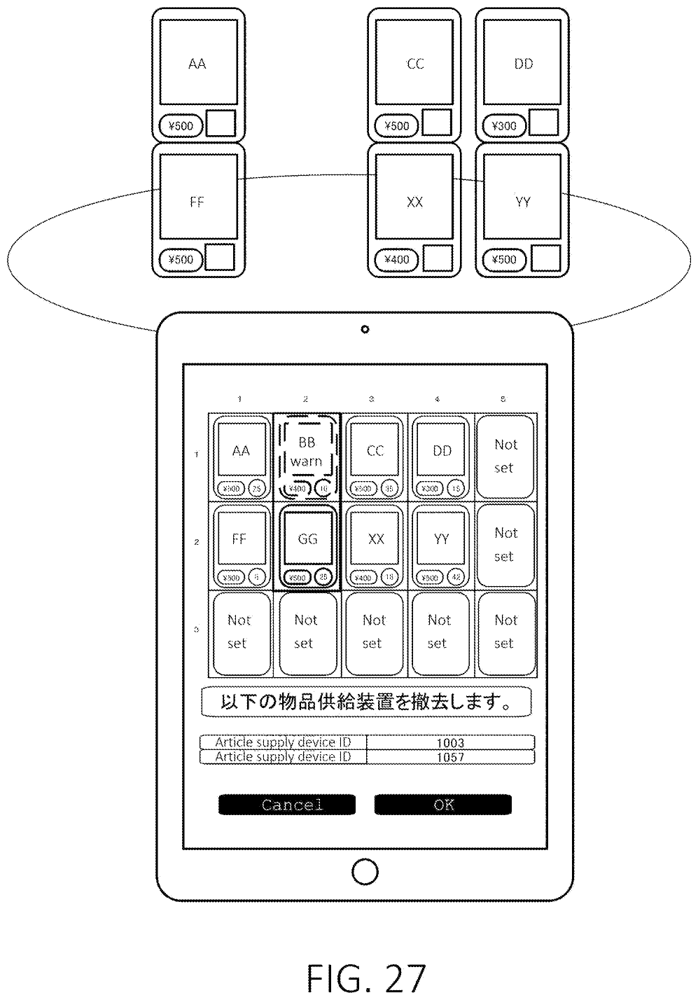

When the removal tab is selected (S215) and a cell at a position of one to be removed on the layout image is selected, the browser control unit 220 of the terminal 2 detects a coordinate of the selected cell and that of a cell which is provided so as to continue from the selected cell in the vertical direction (S216). When the coordinates of the cells are detected, an input screen for “Removal” which is the selected processing details is displayed (Step 217). FIG. 27 is a diagram showing an example of the input screen of “Removal”. On the input screen for the “removal” shown in FIG. 27, the article supply device ID of the article supply device corresponding to the cell at the selected coordinate (2, 2) and the article supply device ID of the article supply device corresponding to the cell at the coordinate (1, 2) which continues in the vertical direction therefrom are displayed.

When the article supply device ID to be removed is confirmed (the article supply device ID “1003” and the article supply device ID “1057” in FIG. 27), and OK is pressed (Step 218), the browser control unit 220 of the terminal 2 transmits removal information (the layout ID, the coordinate of the selected cell and the coordinate of the cell next thereto in the vertical direction) to the management server 3 (Step 219).

Next, an operation of the management server 3 side is explained. The management server 3 receives the removal information (the layout ID, the coordinate of the selected cell and the coordinate of the cell next thereto in the vertical direction), which is updating information (Step 300).

The layout information generation unit 321 of the management server 3 acquires the layout information corresponding to the received layout ID from the recorded layout information (Step 301). The layout information generation unit 321 removes “the article supply device information and the article information” for the coordinate of the selected cell and the coordinate of the cell which continues from the selected in the vertical direction in the layout information by using the removal information (the layout ID, the coordinate of the selected cell and the coordinate of the cell next thereto in the longitudinal direction), thereby updating the layout information (Step 302). And the layout information generation unit 321 assigns a new layout ID to the updated layout information and stores it (Step 303).

The database updating unit 324 of the management server 3 deletes the “article supply device information” for the selected cell coordinate and of the cell at the cell coordinate which continues therefrom in the vertical direction, from the article supply apparatus database 4, thereby updating the article supply device database 4 (Step 304).

The layout image generation unit 322 of the management unit 3 generates object images by using the article supply device information and the article information of each cell of the updated layout information. And the layout image generation unit 322 arranges the object images in cells of the basic layout map, which respectively correspond to the object images, and writes information indicating that no article supply device 1 is set, in a cell(s) where the article supply device information and the article information is not arranged, thereby generating the layout image (Step 305).

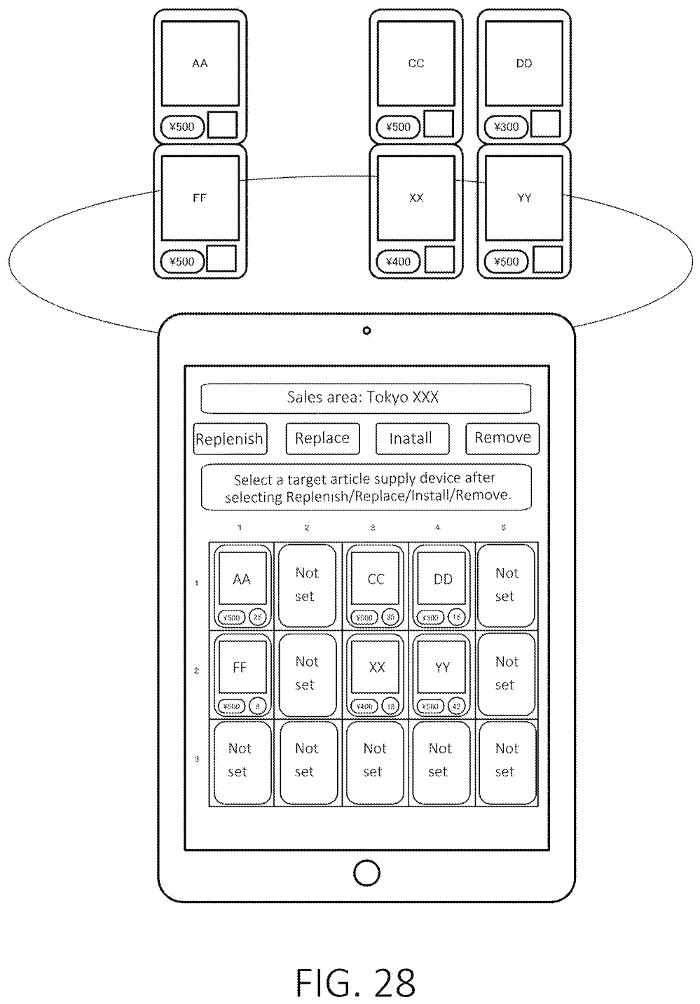

The management server 3 transmits the layout information of the sales area, the layout ID, the layout image and each input screen, to the terminal 2 (Step 306). The terminal 2 receives the layout information of the sales area, the layout ID, the layout image and each of the input screens and displays the layout image which has been updated (Step 12). FIG. 28 is a diagram showing an example of the updated layout image after the information of the removed article supply device is updated. In FIG. 28, the layout image is shown, wherein the object images of the article supply devices in the respective cells at the coordinate (1, 2) and the cell at the coordinate (2, 2) are removed and no setting is made at these positions. Thus, the processing of removal of the article supply device(s) is completed.

According to the present embodiment, a layout image of the article supply devices corresponding to the arrangement layout of article supply devices installed in the sales area is displayed on the terminal. In this layout image, object images corresponding to respective article supply devices are positioned in the same arrangement as that of the article supply devices 1 which are actually installed in the same area. In addition, each object image includes the article information of the article supply device installed in the sales area. The article information includes information on a paper sheet attached to each article supply device, information shown on a display of such an article supply device and/or stock information and price information etc.

A user who visits a sales area compares the article supply devices installed in the sales area with a layout image, so that it is possible to identify each article supply device without hesitation, and to grasp the status thereof. As a result, the efficiency of work for replenishment of articles to an article supply device, replacement of articles, or arrangement or removal of an article supply device(s) can be enhanced. In addition, in the above-described embodiment, the layout image is shown two-dimensionally due to the characteristics of arrangement of the article supply devices. However, it is not limited thereto, and it may be sterically displayed in a three-dimensional space.

### Modified Example 1 of Embodiment of the Present Invention

In the above-described embodiment, it is configured that the management server 3 generate a layout image, and the terminal 2 displays the received layout image. However, the terminal 2 may have a function of generating such a layout image etc. and performing a control therefor. In such case, a dedicated application for performing functions of the layout image generation unit 322 and the input screen generation unit 323 may be installed in the terminal 2. On the other hand, the management server 3 transmits layout information without generating such a layout image. The other operations are the same as those of the above-described embodiment.

### Modified Example 2 of Embodiment of the Present Invention

The layout information generation unit 321 of the management server 3 may generates the layout information of each sales area in advance. The advantages of the generation of the layout information in each sales area in advance is that it is possible to know arrangement of explanation image of articles in each sales area.

The user who visits a sales area takes a photograph of arrangement state of actual article supply devices, and causes the management server 3 to analyze the arrangement of the explanation image of the photographed image. The management server 3 compares the arrangement of the explanation image of the photographed image and the arrangement of the explanation image of each layout information, with each other so that it is possible to identify the sales area the user visits and to generate a layout image from the layout information of the sales area. By such a configuration, the user can omit an input of the sales area.

In the above description, the present invention is explained based on preferred embodiments. However, all the elements in the embodiment are not indispensable and they may be combined with each other as needed. The present invention is not limited to the above-described embodiments, and may be modified in various ways within a scope of the technical idea.

In addition, a part or all of the above-described embodiments may be also described as additional remarks as set forth below. However, it is not limited thereto.

[Additional Remark 1]

In a management method for managing a plurality of article supply devices which can supply article(s), a control is performed so as to be able to present stock information of articles in each of the article supply devices, to an administrator on a layout image reflecting to installation positions of the article supply devices.

[Additional Remark 2]

In the management method according to the above additional remark 1, a control is performed so as to be able to present the price information of an article which can be supplied from each of the article supply devices.

[Additional Remark 3]

In the management method according to the above additional remark 1 or 2, the article supply devices includes paper on which information of suppliable articles is written, and a control is performed so as to be able to present, as image information, the article information, which is written on the payer, on a layout image corresponding to the installation position of the article supply devices.

[Additional Remark 4]

In the management method according to any one of the above additional remarks 1-3, the layout image includes frame images in a longitudinal direction and frame images in a traverse direction, wherein the number of the frame images in a longitudinal direction is a first number and the number of the frame images in a traverse direction is a second number, and the first number is equal to or smaller than the second number.

[Additional Remark 5]

In the management method according to any one of the above additional remarks 1-4, a control is performed so that one of the frame images can be associated with one article supply device.

[Additional Remark 6]

In the management method according to any one of the above additional remarks 1-5, the first number is equal to or smaller than three.

[Additional Remark 7]

In the management method according to any one of the above additional remarks 1-6, a control is performed so that address which can be identified by an administrator is assigned to each frame image.

[Additional Remark 8]

In the management method according to any one of the above additional remarks 1-7, a control is performed so that at least any one of stock information, price information and article information can be presented within a frame image

[Additional Remark 9]

In the management method according to any one of the above additional remarks 1-8, a control is performed so that none of stock information, price information and article information is presented to an administrator on frame images with which any article supply device is not associated.

[Additional Remark 10]

In the management method according to any one of the above additional remarks 1-9, a control is performed so that information indicating no article supply device is set thereto can be presented to the administrator on frame images with which any article supply device is not associated

[Additional Remark 11]

In the management method according to any one of the above additional remarks 1-10, a control is performed so that association can be performed on condition of a selection of a frame image in which information to the effect that a new article supply device is not set, is presented, and an input of device information of the article supply device to be newly associated with the selected frame image and article information.

[Additional Remark 12]

In the management method according to any one of the above additional remarks 1-11, a control is performed so that along with change of the installation position of the article supply device, the frame image is associated so as to correspond to the installation position after the change.

[Additional Remark 13]

In the management method according to any one of the above additional remarks 1-12, a control is performed so that the association with the frame image is canceled on condition of a selection of the frame image associated with an article supply device to be desirably removed.

[Additional Remark 14]

In the management method according to any one of the above additional remarks 1-13, a control is performed so that the article supply devices for which an association with a frame image is canceled includes an article supply device associated with the frame image adjacent to the selected frame image in vertical direction

[Additional Remark 15]

In the management method according to any one of the above additional remarks 1-14, a control is performed so that error information is presented to the administrator on the frame image on condition that an article cannot be supplied from an article supply device associated with the frame image or that stock information cannot be acquired from the article supply device associated therewith.

[Additional Remark 16]

In the management method according to the above additional remark 15, a control is performed so that the error information can be presented in a color different from that of the stock information and price information.

[Additional Remark 17]

In the management method according to any one of the above additional remarks 1-16, a control is performed so that the stock information is changeable according to the number of articles to be replenished to the article supply device.

[Additional Remark 18]

Cloud computing includes a cloud, which is equipped with a an article supply device database which stores arrangement information relating to a layout of each of article supply devices installed in a sales area, stock information of articles which can be supplied from each of the article supply devices, and article information relating to the articles which can be supplied from each of the article supply devices installed in the sales area, and the cloud computing comprises processing for acquiring the stock information of articles which can be supplied from the article supply device installed in the sales area; processing for updating the stock information of the article supply device in the article supply device database by using the acquired stock information; processing for receiving a designation of a sales area from a terminal; processing for acquiring arrangement information of the designated sales area and stock information of each of the article supply devices at the designated sales devices and article information of each of the article supply devices in the predetermined sales area; and processing for displaying, on a user terminal, a layout image in which an object image of each of article supply devices is arranged, corresponding to a layout of the article supply devices in the predetermined sales area by using the arrangement information of the sales area, wherein the object image includes the stock information of the article supply device corresponding to the object image for the article supply devices and article information thereof.

### REFERENCE NUMERALS

1 Article supply device
2 Terminal
3 Management server
4 Article supply device database
21 Display
22 Touch operation panel
201 Processing unit
202 Operation input unit
203 Image display unit
204 Audio output unit
205 Communication unit
206 Memory unit
211 Arithmetic unit
212 Image generation unit
213 Audio generation unit
214 Communication control unit
220 Browser control unit
300 Processing unit
301 Communication unit
302 Memory unit
311 Arithmetic unit
312 Communication control unit
320 Database information acquisition unit
321 Layout information generation unit
322 Layout image generation unit
323 Input screen generation unit
324 Database updating unit

1. An article supply device managing method, comprising the following steps of:
from an article supply device database, which stores arrangement information relating to a layout of article supply devices installed in each of sales areas and article information relating to an article which can be supplied from the article supply devices installed in each of the sales areas, acquiring arrangement information in a predetermined sales area and article information of each of the article supply devices in the predetermined sales area; and
displaying, on a user operating terminal, a layout image where an object image of each of the article supply devices corresponding to the layout of the article supply devices in the predetermined sales area is arranged, by using the article information and the arrangement information of the respective article supply devices in the predetermined sales area,
wherein the object image includes the article information of the article supply device corresponding to the object image.

2. The article supply device managing method according to claim 1, wherein the object image includes at least any of stock information of the article, which can be suppled from each of the article supply devices, price information thereof and explanation information of the article.

3. The article supply device managing method according to claim 2, wherein the explanation information is information which is written on a paper sheet attached to each of the article supply devices installed in the sales area, or information which is displayed on a display screen of each of the article supply devices installed in the sales area.

4. The article supply device managing method according to claim 1, wherein by selecting the object image on the layout image, the article supply device corresponding to the object image is controlled so as to be selectable, and the arrangement information or the article information of the selected article supply device in the article supply device database is controlled so as to be updatable.

5. The article supply device managing method according to claim 4, wherein a control is performed so that a number of articles to be replenished into the selected article supply device can be input, and a stock quantity of the selected article supply device in the article supply device database is updated by using the inputted number of articles to be replenished.

6. The article supply device managing method according to claim 4, wherein the article supply device database is updated on condition of determination of removal of the selected article supply device, and the layout image in which the object image of the article supply device whose removal is determined is deleted, is displayed.

7. (canceled)

8. The article supply device managing method according to claim 1, wherein a control is performed so that an arrangement position of an article supply device to be newly installed in the sales area is selectable on the layout image,
the article supply device database is updated by the arrangement information and the article information of the article supply device which is newly installed, and
a layout image, in which an object image of the article supply device which is newly installed is arranged in the selected arrangement position, is displayed.

9. The article supply device managing method according to claim 1, wherein the layout image comprises a plurality of cells whose positions are respectively identified based on a column and a row thereof, and
in the layout image, an object image corresponding to each article supply device is arranged at a position of each cell corresponding to the arrangement position of each article supply device in the predetermined sales area.

10. The article supply device managing method according to any one of claim 9, wherein in the layout image, an image of information indicating that no article supply device is set, is added to cells where no object image is arranged.

11. The article supply device managing method according to claim 9, wherein the layout image is displayed so that a user can recognizes a position of each cell therein.

12. (canceled)

13. (canceled)

14. A user interface wherein, in a layout image in which an object image of each of article supply devices is arranged corresponding to the article supply devices in a predetermined sales area, is displayed,
the object image includes article information relating to an article which can be supplied from the article supply devices corresponding to the object image, and
a selection of an article supply device whose article information is changed or a selection of an article supply device whose layout change is made by selecting the object image.

15. The user inter face according to claim 14, wherein the object image includes at least any one of stock information of articles which can be supplied from each of the article supply devices, price information thereof, and explanation information of the articles.

16. The user inter face according to claim 15, wherein the explanation information is information which is written on paper sheet attached to each of the article supply device installed in the sales area, or information displayed on a display screen of each of the article supply devices installed in the sales area.

17. The user inter face according to claim 14, wherein the changed layout, or the changed article information is reflected to the layout image.

18. (canceled)

19. The user inter face according to claim 14, wherein an input screen for inputting information about replenishment of articles, replacement thereof, installation of an article supply device or removal thereof is displayed outside an area of the layout image.

20. The user inter face according to claim 14, wherein the layout image comprises a plurality of cells whose positions are respectively identified based on a column and a row thereof, and
in the layout image, an object image corresponding to each of the article supply device is arranged at a position of a cell corresponding to an arrangement position of each of the article supply devices in the predetermined sales area.

21. The user inter face according to claim 14, wherein in the layout image, an image of information indicating that no article supply device is set, is arranged in cells where no object image is arranged.

22. The user inter face according to claim 20, wherein the layout image is displayed so that a user can recognizes a position of each cell therein.

23. An article supply device managing apparatus comprising:
an acquiring unit which acquires, from an article supply device database, which stores arrangement information relating to a layout of article supply devices installed in each of sales areas and article information relating to an article which can be supplied from the article supply devices installed in each of the sales areas, arrangement information of the respective article supply devices in a predetermined sales area and the article information of each of the article supply devices in the predetermined sales area; and
a display control unit which, on a user operating terminal, displays a layout image where an object image of each of the article supply devices corresponding to the layout of the article supply devices in the predetermined sales area is arranged by using the article information and the arrangement information of the respective article supply devices in the predetermined sales area,
wherein the object image includes the article information of the article supply device corresponding to the object image.

24. (canceled)

25. (canceled)
